(19) United States
(12) Patent Application Publication
(10) Pub. No.: US 2026/0106438 A1
(43) Pub. Date: Apr. 16, 2026

(54) ELECTRICAL WIRE SEAL

(71) Applicant: Lear Corporation, Southfield, MI (US)

(72) Inventors: Jordi Angel Serrano, Remscheid (DE); Ivo Micola, Brno (CZ); Oliver Regolin, Wismar (DE); Xavier Farre Vives, Valls (ES)

(73) Assignee: Lear Corporation, Southfield, MI (US)

(21) Appl. No.: 18/913,728

(22) Filed: Oct. 11, 2024

(51) Int. Cl. H02G 3/08; H02G 3/16

(52) U.S. Cl. CPC H02G 3/088; H02G 3/083; H02G 3/16

(57) ABSTRACT

A wire seal cap includes a wire seal and a retainer. The retainer includes a retainer body. A first arm extends from the retainer body. A second arm extends from the retainer body. The first arm is free of contact with the second arm. The wire seal includes a seal body. The seal body surrounds a portion of the retainer body. A seal opening extends through the seal body.

### FIELD

This disclosure relates to a seal for an electrical conductor. More specifically, this disclosure relates to an improved seal positioned around an electrical conductor used in a wall pass through.

### BACKGROUND

Electrical boxes can hold multiple electrical components that are connected to other electrical located outside the electrical box, this may be accomplished by electrical conductors, such as wires and cables, that extend through a wall of the electrical box. In some cases, it is desirable to seal the electrical box in order to limit water and other environmental contaminants from getting into the box. In order to seal the electrical box, a wire seal is provided between the electrical conductor and the wall of the electrical box. It is desirable to provide an improved wire seal.

### SUMMARY

Various example electrical wire seal caps and assemblies are described.

An example wire seal cap includes a wire seal and a retainer. The retainer includes a retainer body. A first arm extends from the retainer body. A second arm extends from the retainer body. The first arm is free of contact with the second arm. The wire seal includes a seal body. The seal body surrounds a portion of the retainer body. A seal opening extends through the seal body.

Another example is an assembly that includes a wire seal cap. The assembly includes a housing that has a wall. The wall includes a wall opening. The housing includes a first catch and a second catch. The housing includes a seal groove, and the seal body is located in the seal groove. The seal opening defines an opening axis that extends through the wall opening. The first arm engages the first catch to retain the wire seal cap in an installed position relative to the housing. The second arm engages the second catch on the housing to retain the wire seal cap in the installed position relative to the housing.

Additional understanding of these examples will become apparent to those skilled in the art from the following detailed description, when read in light of the accompanying drawings.

### BRIEF DESCRIPTION OF THE DRAWINGS

FIG. 1 is a front partial perspective view of an example electrical box assembly.

FIG. 2 is a partial exploded view of the example electrical box assembly illustrated in FIG. 1.

FIG. 3 is a partial enlarged perspective view of an electrical conductor and a wire seal cap from the electrical box assembly illustrated in FIGS. 1 and 2.

FIG. 4 is an enlarged view of a wire seal cap illustrated in FIG. 3.

FIG. 5 is a perspective view of retainer from the wire seal cap illustrated in FIG. 4.

FIG. 6 is an end view of the wire seal cap illustrated in FIG. 4.

FIG. 7 is a cross-sectional view taken along the line 7-7 in FIG. 6.

FIG. 8 is an enlarged top plan view of an opening through a wall of a housing of the electrical box assembly illustrated in FIG. 2.

FIG. 9 is a perspective cut-away view of the electrical conductor and wire seal cap illustrated in FIG. 3 and the opening illustrated in FIG. 8.

FIG. 10 is a cross-sectional view taken along the line 10-10 in FIG. 9.

FIG. 11 is a cross-sectional view similar to FIG. 10, with a cover shown attached in a cover position.

FIG. 12 is a cross-sectional view of the electrical box assembly 10 illustrated in FIG. 1, taken along the line 12-12 in FIG. 11

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details.

In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are only used to distinguish one element from another. For example, a first shield could be termed a second shield, and, similarly, a second shield could be termed a first shield, without departing from the scope of the various described embodiments. The first shield and the second shield are both shields, but they are not the same shield.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

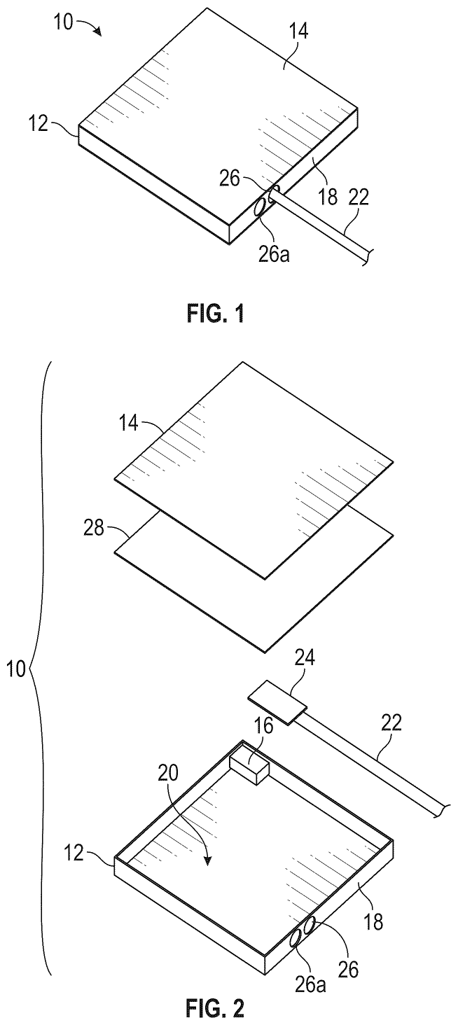

Referring now to the drawings there is illustrated in FIG. 1 a front perspective schematic view of an electrical box assembly, indicated generally at 10. A partially exploded view of the electrical box assembly 10 is illustrated in FIG. 2. The electrical box assembly 10 includes a housing 12 and a cover 14. The cover 14 is removable from the housing 12, and a lock 16 retains the cover 14 in a cover position relative to the housing 12, shown in FIG. 1. The housing 12 includes a wall 18 that defines an interior 20.

An electrical cable 22 is attached to an electrical terminal 24. The electrical terminal 24 is adapted to connect to an electrical component (not shown) located in the interior, located generally at 20, of the housing 12, and the electrical cable 22 is adapted to pass through a wall opening 26 in the wall 18, in order to allow to the electrical cable 22 to be attached to a second electrical component (not shown) located outside the housing 12. A cover seal 28 is located between the housing 12 and the cover 14 when the cover 14 is in the cover position relative to the housing 12, in order to seal the interior 20 from the environment outside the housing 12 when the cover 14 is in the cover position.

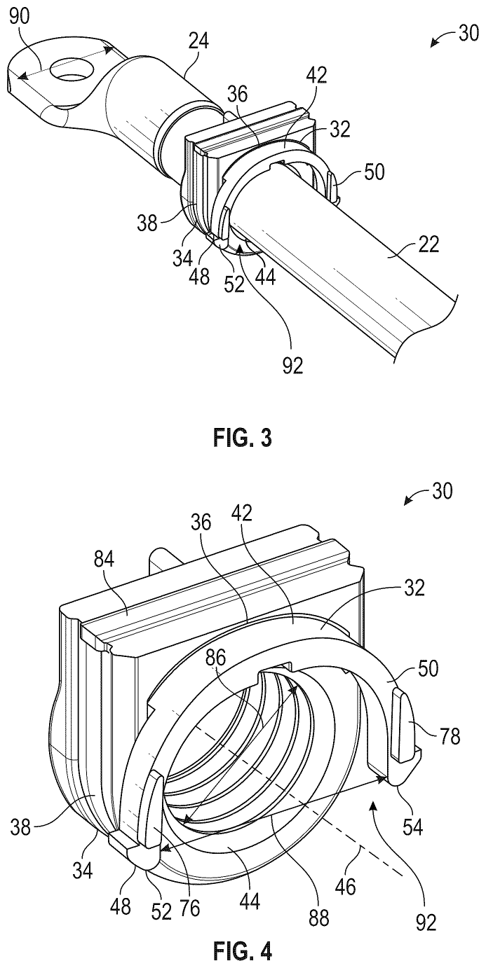

FIG. 3 is an enlarged, perspective view of the electrical cable 22, the electrical terminal 24, and a wire seal cap, indicated generally at 30. FIG. 4 is a perspective view of the wire seal cap 30. The wire seal cap 30 includes a retainer 32 and a wire seal 34. The illustrated retainer 32 is molded from plastic but in other embodiments is made of another suitable material using another desired process. The illustrated wire seal 34 is molded from an elastomeric material but in other embodiments is made of another suitable material using another desired process. The retainer 32 includes a retainer body 36 and the wire seal 34 includes a seal body 38 that is attached to the retainer body 36.

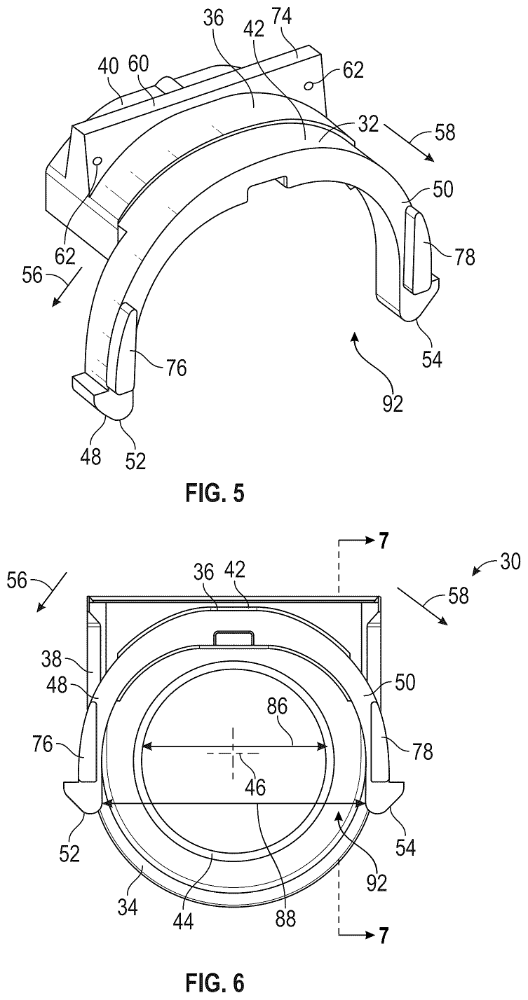

FIG. 5 is a perspective view of the retainer 32. The retainer body 36 includes a first portion 40 and a second portion 42. The seal body 38 surrounds the first portion 40 of the retainer body 36 when assembled. In the illustrated embodiment, the wire seal 34 is overmolded onto the first portion 40 of the retainer body 36. However, in other embodiments, the wire seal 34 is attached to the retainer body 36 by another desired process. As shown in FIGS. 3 and 4, the wire seal 34 includes a seal opening 44 that extends through the seal body 38. The seal opening defines an opening axis 46.

The second portion 42 of the retainer body 36 extends out of the seal body 38 and is not surrounded by the seal body 38. The retainer 32 includes a first arm 48 that extends from the retainer body 36 and a second arm 50 that extends from the retainer body 36. The first arm 48 extends from the second portion 42 of the retainer body 36 and the second arm 50 extends from the second portion 42 of the retainer body 36. The first arm 48 is free of contact with the second arm 50. The first arm 48 extends from the retainer body 36 to a first end 52 and does not contact the second arm 50. Similarly, the second arm 50 extends from the retainer body 36 to a second end 54 and does not contact the first arm 48.

FIG. 6 is an end view of the wire seal cap 30, viewed along the opening axis 46. The first arm 48 extends from the retainer body 36 in a first direction 56. The second arm 50 extends from the retainer body 36 in a second direction 58. The second direction 58 is different from the first direction 56. As illustrated in FIG. 6, in the illustrated embodiment, parts of the first arm 48 and the second arm 50 are on the opposite sides of the opening axis 46.

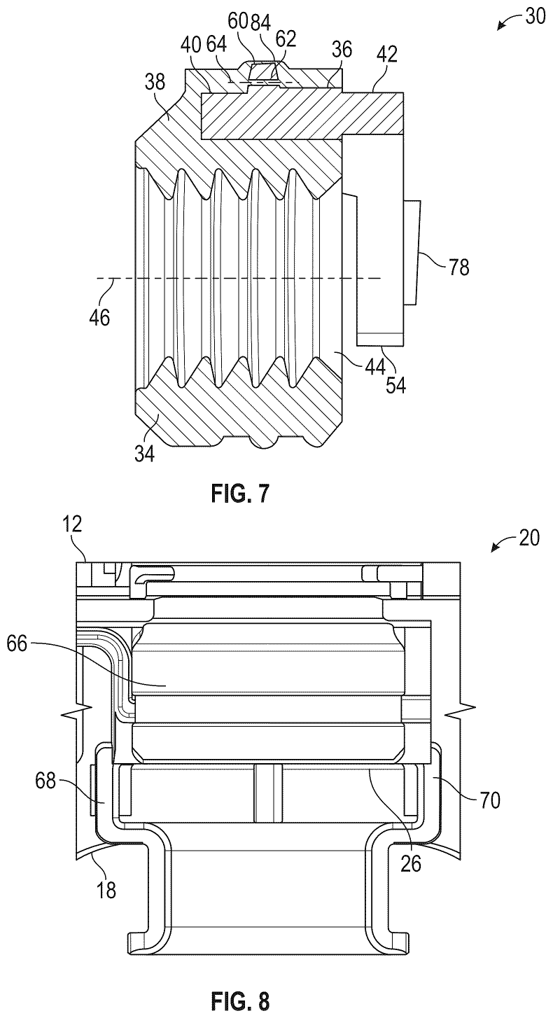

FIG. 7 is a cross-sectional view taken along the line 7-7 in FIG. 6. The retainer 32 includes a ridge 60 that extends from the retainer body 36. The ridge 60 extends from the first portion 40 of the retainer body 36 and the ridge 60 is surrounded by the seal body 38. The ridge 60 is located on the opposite side of the retainer body 36 from the seal opening 44. The ridge 60 includes a ridge opening 62 that extends through the ridge 60. The ridge opening 62 defines a ridge opening axis 64, and the illustrated ridge opening axis 64 is parallel to the opening axis 46.

A portion of the seal body 38 is located in the ridge opening 62. In the illustrated embodiment, during molding of the wire seal 34, the material flows through the ridge opening 62. This increases the strength of the connection between the seal body 38 and the retainer 32. Referring back to FIG. 5, the illustrated retainer 32 includes two ridge openings 62, located near opposite ends of the ridge 60.

Referring back to FIG. 3, the wire seal cap 30 is shown attached to the electrical cable 22. As shown, the electrical terminal 24 is connected to the electrical cable 22 on one side of the wire seal cap 30. The electrical cable 22 extends through the seal opening 44 and extends parallel to the opening axis 46. The first arm 48 and the second arm 50 are located on opposite sides of the electrical cable 22.

FIG. 8 is an enlarged, overhead plan view of part of the wall 18 of the housing 12, illustrating the wall opening 26. The housing 12 includes a seal groove 66 that is located in the wall opening 26. The seal groove 66 is adapted to accommodate the wire seal 34, as described below. The housing 12 also includes a first catch 68 and a second catch 70 that are located near the seal groove 66. The first catch 68 and the second catch 70 are adapted to engage the first arm 48 and the second arm 50, respectively, as described below.

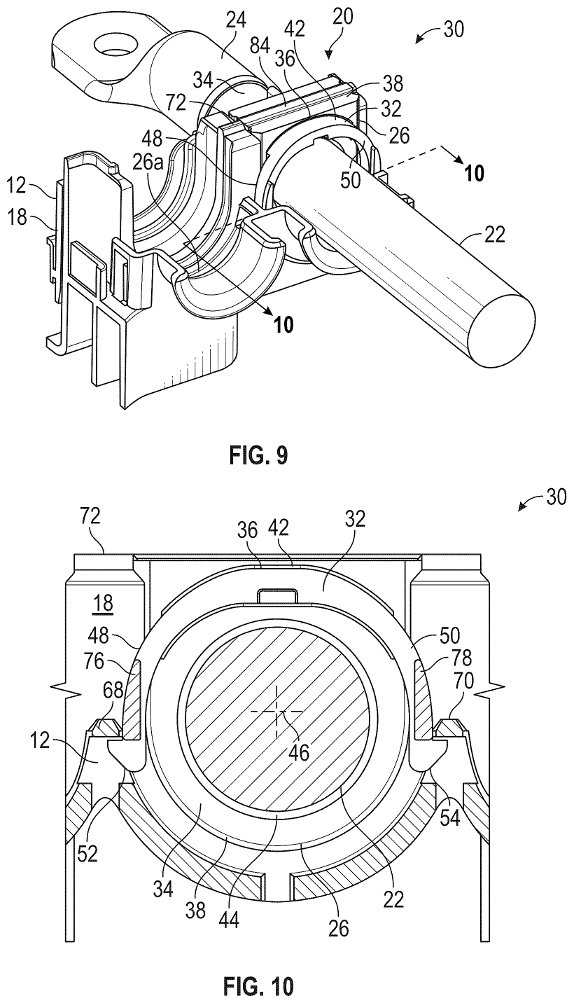

FIG. 9 is a perspective view of a part of the wall 18 of the housing 12, illustrating the wall opening 26 with the wire seal cap 30 in an installed position relative to the housing 12. Also illustrated in FIG. 9 is a second wall opening 26a through the wall 18. During assembly of the electrical box assembly 10, a second electrical cable (not shown) and a second wire seal cap (not shown) may be installed through the second wall opening 26a. The housing 12 may include any desired number of wall openings 26a, and those wall openings 26a may be of any desired size. FIG. 10 is a cross-sectional view taken along the line 10-10 in FIG. 9. When the wire seal cap 30 is in the installed position, the wire seal 34 is positioned so that a portion of the seal body 38 in located in the seal groove 66 (not visible in FIG. 10) and is located in the wall opening 26. The first arm 48 engages the first catch 68 on the housing 12 to retain the wire seal cap 30 in the installed position relative to the housing 12. Also, the second arm 50 engages the second catch 70 on the housing 12 to retain the wire seal cap 30 in the installed position relative to the housing 12. When the wire seal cap 30 is in the installed position, the opening axis 46 extends through the wall opening 26. When the wire seal cap 30 is in the installed position, the electrical cable 22 extends through the wall opening 26 to the interior 20 of the housing 12.

The wall 18 includes a wall surface 72 that is located at a side of the wall opening 26 opposite the seal groove 66. As shown in FIG. 5, the ridge 60 includes a ridge surface 74 that is located on a side of the ridge 60 opposite the retainer body 36. When the wire seal cap 30 is in the installed position, the ridge surface 74 is substantially parallel to the wall surface 72.

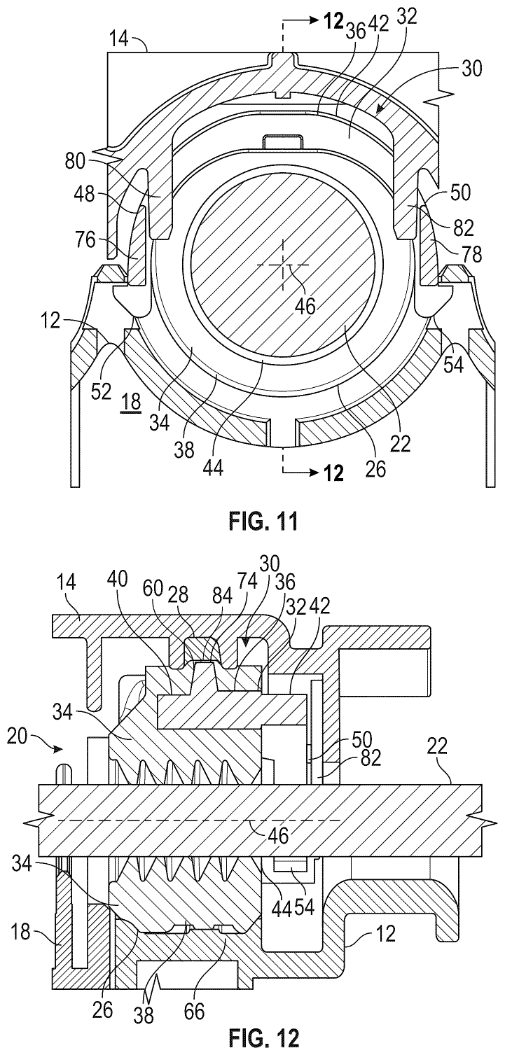

FIG. 11 is a cross-sectional view similar to FIG. 10, with the cover 14 shown in the installed position relative to the housing 12. FIG. 12 is a cross-sectional view of the electrical box assembly 10 shown in FIG. 1, taken along the line 12-12 in FIG. 11. As shown in FIG. 11, the first arm 48 includes a first stop 76 that extends parallel to the opening axis 46 and the second arm 50 includes a second stop 78 that extends parallel to the opening axis 46. The first stop 76 and the second stop 78 are seen in FIG. 4. Referring back to FIG. 11, the cover 14 includes a first block 80 and a second block 82. When the cover 14 is in the cover position, the first block 80 is located between the first stop 76 and the seal opening 44, and the second block 82 is located between the second stop 78 and the seal opening 44. The first stop 76 and the first block 80 act as a lock to prevent the first arm 48 from releasing from the first catch 68. Similarly, the second stop 78 and the second block 82 act as a lock to prevent the second arm 50 from releasing from the second catch 70. This retains the wire seal cap 30 in the installed position relative to the housing 12.

Referring back to FIG. 4, the wire seal 34 includes an outer edge 84. As seen in FIG. 7, the ridge 60 extends from the retainer body 36 towards the outer edge 84 of the wire seal 34. As shown in FIG. 12, when the cover 14 is in the installed position, the cover seal 28 is located between the cover 14 and the outer edge 84 of the wire seal 34.

Additionally, as described previously in reference to FIG. 2, the cover seal 28 is located between the housing 12 and the cover 14, and the cover seal 28 is located between the cover 14 and the wall surface 72.

In order to use the wire seal cap 30, the electrical cable 22 is inserted through the seal opening 44 and the electrical terminal 24 is attached to the electrical cable 22, as shown in FIG. 3. The wire seal 34 is then positioned as illustrated in FIG. 9, with the wire seal 34 in the seal groove 66 and the electrical terminal 24 in the interior 20 of the housing 12. The electrical terminal 24 is then connected to the electrical component in the housing 12. If the electrical terminal 24 or the wire seal cap 30 are damaged, it may be desirable to service or replace the electrical terminal 24 or the wire seal cap 30. In conventional practice, the electrical cable 22 would be cut in order to separate the electrical cable 22 and electrical terminal 24 from the wire seal cap 30. However, the wire seal cap 30 allows the electrical cable 22 and electrical terminal 24 to be separated from the wire seal cap 30 without cutting the electrical cable 22.

As shown in FIG. 6, the seal opening 44 has a seal opening width 86, which is measured perpendicular to the opening axis 46. Additionally, the first arm 48 and the second arm 50 are separated by a retainer width 88, which is also measured perpendicular to the opening axis 46. As shown in FIG. 3, the electrical terminal 24 has a terminal width 90, measured perpendicular to the opening axis 46. The illustrated terminal width 90 is greater than the illustrated opening width 86 and is also greater than the illustrated retainer width 88.

In order to separate the electrical cable 22 and the electrical terminal 24 from the wire seal cap 30, the wire seal cap 30 is moved relative to the electrical cable 22 toward the electrical terminal 24. As previously described, the wire seal 34 is made of an elastomeric material, and the wire seal 34 and may be stretched in order to enlarge the size of the seal opening 86 in order to allow the electrical terminal 24 to be moved through the seal opening 44. Additionally, as previously described, the first arm 48 is free of contact with the second arm 50 and there is a gap, indicated generally at 92, between the first arm 48 and the second arm 50. The wire seal 34 may be oriented relative to the electrical terminal 24 so that the electrical terminal 24 is located at least partially in the gap 92 and the wire seal 34 may be moved relative to the electrical cable 22 past the electrical terminal 24, despite the terminal width 90 being larger than the retainer width 88. This allows the wire seal cap 30 to be removed from the electrical cable 22 after the electrical terminal 24 is attached, while leaving the electrical cable 22 intact.

Those with ordinary skill in the art will appreciate that various modifications and alternatives for the described and illustrated embodiments can be developed in light of the overall teachings of the disclosure, and that the various elements and features of one example described and illustrated herein can be combined with various elements and features of another example without departing from the scope of the invention. Accordingly, the particular example disclosed herein has been selected by the inventor(s) simply to describe and illustrate an example of the invention and is not intended to limit the scope of the invention or its protection, which is to be given the full breadth of the appended claims and any and all equivalents thereof.

1. A wire seal cap comprising:
a retainer comprising a retainer body, a first arm, and a second arm, the first arm extending from the retainer body, the second arm extending from the retainer body, the first arm being free of contact with the second arm; and
a wire seal comprising a seal body and a seal opening, the seal body surrounding a portion of the retainer body, the seal opening extending through the seal body.

2. The wire seal cap of claim 1, wherein the seal opening defines an opening axis; and
wherein the first arm and the second arm are located on opposite sides of the opening axis.

3. The wire seal cap of claim 1, wherein retainer body comprises a second portion that is not surrounded by the wire seal; and
wherein the first arm and second arm extend from the second portion.

4. The wire seal cap of claim 1, wherein the seal opening defines an opening axis;
wherein the first arm extends from the retainer body in a first direction relative to the opening axis; and
wherein the second arm extends from the retainer body in a second direction relative to the opening axis that is different from the first direction.

5. The wire seal cap of claim 1, wherein the retainer comprises a ridge extending from the portion of the retainer body that is surrounded by the seal body.

6. The wire seal cap of claim 5, wherein the ridge comprises a ridge opening extending through the ridge; and
wherein a portion of the seal body is located in the ridge opening.

7. The wire seal cap of claim 6, wherein the seal opening defines an opening axis; and
wherein the ridge opening defines a ridge opening axis that is parallel to the opening axis.

8. The wire seal cap of claim 5, wherein the ridge and the seal opening are located on opposite sides of the retainer body.

9. The wire seal cap of claim 1, wherein the seal opening defines an opening axis;
wherein the first arm comprises a first stop extending parallel to the opening axis; and
wherein the second arm comprises a second stop extending parallel to opening axis.

10. An assembly comprising the wire seal cap of claim 1 and a housing, the housing comprising a wall, a seal groove, and a catch, the wall comprising a wall opening;
wherein the seal body is located in the seal groove and the seal opening defines an opening axis that extends through the wall opening; and
wherein the first arm engages the catch on the housing to retain the wire seal cap in an installed position relative to the housing.

11. The assembly of claim 10, wherein the catch is a first catch;
wherein the housing comprises a second catch; and
wherein the second arm engages the second catch to retain the wire seal cap in the installed position relative to the housing.

12. The assembly of claim 11, wherein the seal opening defines an opening axis; and
wherein the first arm and the second arm are located on opposite sides on the opening axis.

13. The assembly of claim 11, wherein the seal opening defines an opening axis;
wherein the first arm extends from the retainer body in a first direction relative to the opening axis; and
wherein the second arm extends from the retainer body in a second direction relative to the opening axis that is different from the first direction.

14. The assembly of claim 11, wherein the wall comprises a wall surface; and
wherein the retainer comprises a ridge extending from the portion of the retainer body that is surrounded by the seal body, the ridge comprising a ridge surface located on a side of the ridge opposite the retainer body that is substantially parallel to the wall surface of the wall.

15. The assembly of claim 14, wherein the ridge and the seal opening are located on opposite sides of the retainer body.

16. The assembly of claim 11, wherein the seal opening defines an opening axis;
wherein the first arm comprises a first stop extending parallel to the opening axis; and
wherein the second arm comprises a second stop extending parallel to opening axis.

17. The assembly of claim 10, wherein the wall has a wall surface;
wherein the seal body has an outer edge; and
further comprising a cover and a cover seal, the cover engaging the housing to retain the cover in a cover position relative to the housing, the cover seal located between the cover and the wall surface of the wall, the cover seal located between the cover and the outer edge of the seal body.

18. The assembly of claim 17, wherein the retainer comprises a ridge extending from the portion of the retainer body that is surrounded by the seal body towards the outer edge of the seal body, the ridge comprising a ridge surface located on a side of the ridge opposite the retainer body that is substantially parallel to the wall surface of the wall.

19. The assembly of claim 17, wherein the seal opening defines an opening axis;
wherein the first arm comprises a first stop extending parallel to the opening axis;
wherein the second arm comprises a second stop extending parallel to opening axis; and
wherein the cover comprises a first block and a second block, the first block located between the first stop and the seal opening, the second block located between the second stop and the seal opening.

20. An assembly comprising:
a wire seal cap comprising:
a retainer comprising a retainer body, a first arm, and a second arm, the first arm extending from the retainer body, the second arm extending from the retainer body, the first arm being free of contact with the second arm; and
a wire seal comprising a seal body and a seal opening, the seal body surrounding a portion of the retainer body, the seal opening extending through the seal body; and
a housing comprising:
a wall comprising a wall opening;
a first catch, and a second catch; and
a seal groove within which the seal body is located;
wherein the seal opening defines an opening axis extending through the wall opening; and
wherein the first arm engages the first catch on the housing and the second arm engages the second catch on the housing to retain the wire seal cap in an installed position relative to the housing.
